(19) United States
(12) Patent Application Publication
(10) Pub. No.: US 2026/0316154 A1
(43) Pub. Date: Oct. 15, 2026

(54) RIGID ELECTRICAL POWER TRANSMISSION SYSTEM FOR LINEAR MOVEMENT

(71) Applicant: Generational Systems, LLC, Auburn, AL (US)

(72) Inventors: Michael Knotts, Montgomery, AL (US); Travis Thompson, Auburn, AL (US); Jason Smith, Opelika, AL (US)

(21) Appl. No.: 19/464,304

(22) Filed: Jan. 29, 2026

Related U.S. Application Data
(63) Continuation of application No. PCT/US2024/040321, filed on Jul. 31, 2024.
(60) Provisional application No. 63/530,050, filed on Jul. 31, 2023.

(51) Int. Cl. B22D 23/00; B33Y 30/00; H01F 27/16

(52) U.S. Cl. CPC B22D 23/003; B33Y 30/00; H01F 27/16

(57) ABSTRACT

A power transmission assembly (100) for a 3D printer (110) having a printing chamber (112), a print head (114), and an inductive coil (116) wound around at least a portion of the print head (114) is disclosed. The power transmission assembly (100) may include a first lead (140). At least a portion of the first lead (140) may be configured to be positioned within the printing chamber (112) of the 3D printer (110). The first lead (140) may also be configured to be coupled to a power source (102) external to the 3D printer (110). The power transmission assembly (100) may include a second lead (160). The second lead (160) may be configured to be positioned within the printing chamber (112) of the 3D printer (110). The second lead (160) may be slidably coupled to and in electrical contact with the first lead (140).

### CROSS-REFERENCES TO RELATED APPLICATIONS

The present application is a continuation of International Patent Application No. PCT/US2024/040321, filed Jul. 31, 2024, which claims priority to U.S. Provisional Patent Application Ser. No. 63/530,050 filed Jul. 31, 2023, both applications incorporated by reference.

### TECHNICAL FIELD

The present disclosure relates generally to the field of additive manufacturing, also known as 3D printing. More particularly, the present disclosure pertains to 3D printers for manufacturing metallic articles of manufacture.

### BACKGROUND ART

Metal additive manufacturing, commonly known as metal 3D printing, utilizes various methods to create solid metal objects. These methods include powder bed fusion, direct energy deposition, binder jetting, and bound powder extrusion. Each process involves depositing metal powder feedstock onto a printing area and applying heat to bind the powder into a solid object.

For instance, in powder bed fusion, a thin layer of powder is spread over the print area, and a cross-section of the final product is selectively melted into the powder layer using a laser or electron beam. This process is repeated layer by layer to build the complete object.

Direct energy deposition involves depositing metal powder and fusing it together using a laser, sometimes with the aid of metal wire. The laser melts and fuses the feedstock to form the final product.

Binder jetting, another method, includes spreading a thin layer of metal powder over the print area and selectively spraying a binding polymer onto the powder to create a cross-section of the desired object. This layer-by-layer process is repeated, and the bound metal powder is then sintered to remove the binding agent and fuse the layers into the final product.

Bound powder extrusion involves extruding metal powder bound in a waxy polymer to form an intermediate product, which is subsequently sintered to remove the polymer and fuse the metal powder into the final object.

Despite their advantages, existing metal 3D printing techniques have certain drawbacks. The cost of metal 3D printers can be significant, ranging from several hundred thousand to over a million dollars depending on the method. Moreover, the metal powder required for these techniques is expensive and potentially hazardous to handle. Additionally, these methods may have long printing times, and smaller, more economical printers are limited to manufacturing relatively small objects. Although some direct energy deposition printers can use metal wire as raw material, their low print resolutions restrict them to large-scale printing and are not commonly used.

In contrast, for non-metal 3D printing, a widely-used technique is fusion deposition modeling. This method involves melting a thin thermoplastic filament and extruding the molten material in a pattern. Traditional fusion deposition modeling printers employ resistive heating elements, which consume higher amounts of energy compared to other heating methods and have limited heating rates. For prolonged print schedules, the resistive heating elements may require cooling periods to limit wear or overheating of the resistive heating element.

### SUMMARY OF INVENTION

In view of at least some of the above-referenced problems in conventional fused deposition metal 3D printing, an exemplary object of the present disclosure may be to provide an improved assembly and system for providing power and cooling to a print head of a 3D printer. The improved power transmission assembly may provide electrical power to a print head allowing axial motion during the course of the print. The power transmission assembly may be designed to be rigid so that it can seamlessly travel while in a closed environment, allowing for a seal at the point of entry into the chamber. The improved power transmission assembly may feature two concentric telescoping electrical leads, the benefit of which may include the ability to supply cooling water therethrough to the inductive coil wound about the print head.

In some exemplary embodiments, the power transmission assembly of the present disclosure is for a 3D printer having a printing chamber, a print head, and an inductive coil wound around at least a portion of the print head. The power transmission assembly may include a first lead. At least a portion of the first lead may be configured to be positioned within the printing chamber of the 3D printer. The first lead may be configured to be coupled to a power source external to the 3D printer. The power transmission assembly may also include a second lead. The second lead may be configured to be positioned within the printing chamber of the 3D printer. The second lead may be slidably coupled to and in electrical contact with the first lead. The first and second leads are configured to transmit power from the power source to the inductive coil.

In other exemplary embodiments, the power transmission assembly of the present disclosure is for a 3D printer. The power transmission system may include one or more of a first supply lead, a second supply lead, a first return lead, a second return lead, and a conductive coil. The first supply lead may be rigidly coupled to a chamber of the 3D printer and coupled to a power source. The second supply lead may be slidably received by the first supply lead and in electrical contact with the first supply lead. The first return lead may be rigidly coupled to the chamber of the 3D printer and coupled to the power source. The second return lead may be slidably received by the first return lead and in electrical contact with the first return lead. The conductive coil may be wound around a print head of the 3D printer and may include a first coil end and a second coil end. The second supply lead may be coupled to the first coil end, and the second return lead may be coupled to the second coil end.

Other aspects of the invention are described further with respect to the description of embodiments and the claims.

### BRIEF DESCRIPTION OF DRAWINGS

FIG. 1 is a side elevational view of an embodiment of a power transmission assembly in combination with a 3D printer in accordance with the present disclosure.

FIG. 2 is a top front right perspective view of the power transmission assembly of FIG. 1 in accordance with the present disclosure.

FIG. 3 is bottom rear left perspective view of the power transmission assembly of FIG. 1 in accordance with the present disclosure.

FIG. 4 is top plan view of the power transmission assembly of FIG. 1 in accordance with the present disclosure.

FIG. 5 is a top rear left exploded perspective view of the power transmission assembly of FIG. 1 in accordance with the present disclosure.

FIG. 6 is a cross-section elevational view of the power transmission assembly of FIG. 1 in accordance with the present disclosure.

FIG. 7 is a top front right perspective view of another embodiment of a power transmission assembly in accordance with the present disclosure.

FIG. 8 is a top rear left exploded perspective view of the power transmission assembly of FIG. 7 in accordance with the present disclosure.

FIG. 9 is a side elevational view of the power transmission assembly of FIG. 7 in accordance with the present disclosure.

### DESCRIPTION OF EMBODIMENTS

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

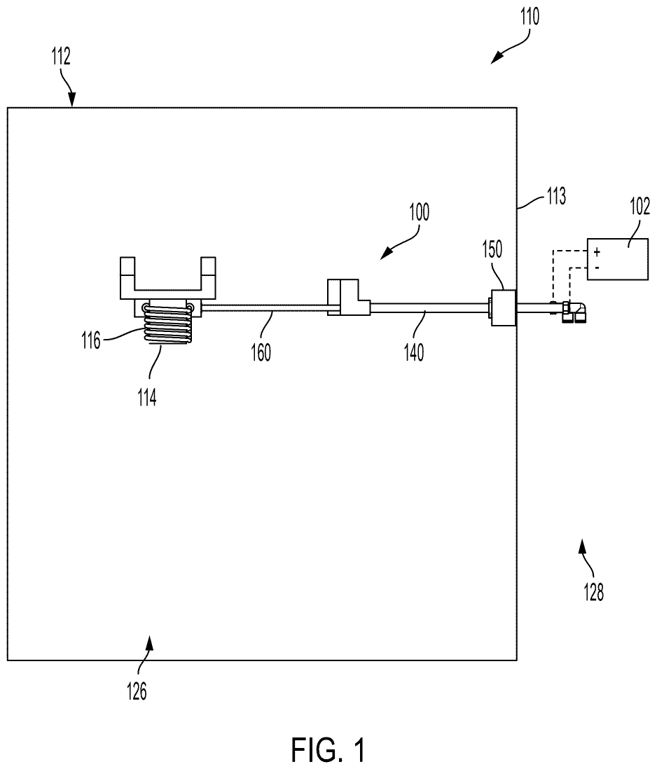

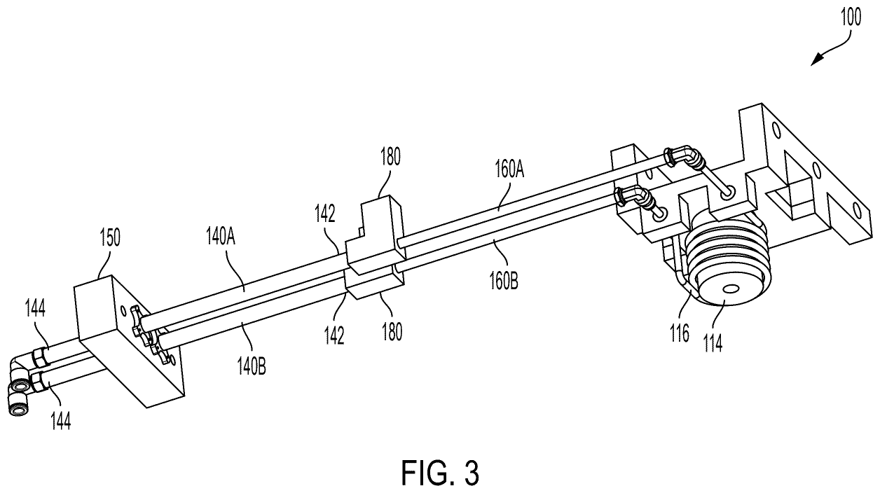

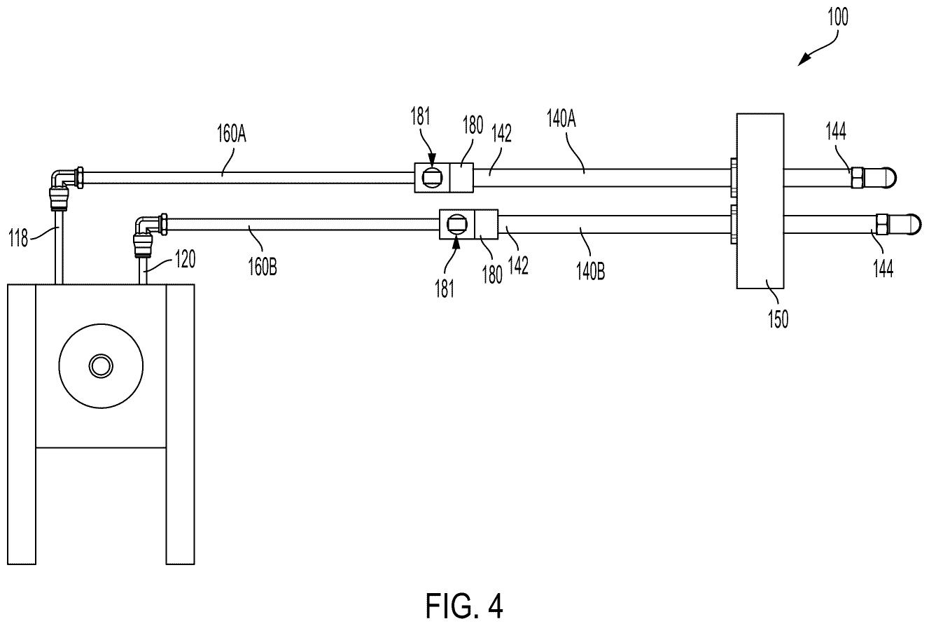

Referring to FIGS. 1-6, a power transmission assembly 100 for a 3D printer 110 is disclosed herein. The 3D printer 110 may also be referred to herein as a metal 3D printer 110. The 3D printer 110 may include a print chamber 112, a print head 114, and an inductive coil 116 wound around at least a portion of the print head 114. The print chamber 112 may define a closed environment 126 therein. The closed environment 126 may be separate from and isolated from an open environment 128 which is external to and surrounds the print chamber 112. The print head 114 may be configured to melt metal feedstock (not shown) and dispense the liquified metal (not shown) during a 3D printing process. The inductive coil 116 may be used to help the print head 114 melt the metal feedstock. The liquified metal may be dispensed from the print head 114 onto a build substrate (not shown) for building the 3D object. In certain optional embodiments, the build substrate may be configured to move along at least one axis using one or more motors (not shown) during the 3D printing process.

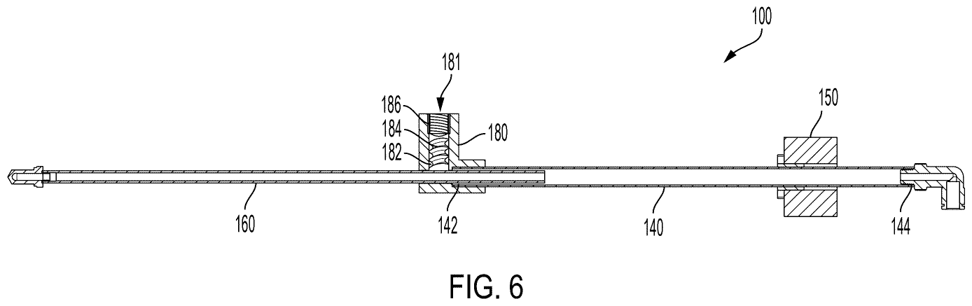

As illustrated in FIGS. 1 and 6, the power transmission assembly 100 may include at least one first lead 140 and at least one second lead 160. The at least one first lead 140 may also be referred to herein as at least one first hollow lead 140 or at least one first tubular lead 140. The at least one second lead 160 may also be referred to herein as at least one second hollow lead 160 or at least one second tubular lead 160. The at least one first lead 140 may be coupled to the print chamber 112 of the 3D printer 110. The at least one first lead 140 may include a first end 142 configured to be positioned within the print chamber 112 (e.g., within the closed environment 126) and a second end 144 configured to be positioned outside of the print chamber 112 (e.g., extending into the open environment 128). As such, the at least one first lead 140 may extend through a wall 113 of the print chamber 112. In certain optional embodiments, the wall 113 may be a sidewall of the print chamber 112. In other optional embodiments, the at least one first lead 140 may alternatively be routed through a ceiling of the print chamber 112, a platform of the print chamber 112, or through any other part of the print chamber 112, all of which may be considered walls 113 of the print chamber 112. The at least one first lead 140 may be rigidly coupled to the wall 113 using a non-conductive housing block 150. The non-conductive housing block 150 may separate the at least one first lead 140 from touching the wall 113 of the print chamber 112 (e.g., to insulate the at least one first lead 140 from the print chamber 112). The non-conductive housing block 150 may be configured to create a seal between the closed environment 126 and the open environment 128 outside of the print chamber 112. The non-conductive housing block 150 may be made from a non-conductive thermally resistant material. The first and second leads 140, 160 pass through holes of the non-conductive housing block 150 with tight-tolerances to their OD to ensure a secure fit. The first and second leads 140, 160 may be held in place via set screws received from the side of the block.

Each of the at least one second lead 160 may be at least partially received into the first end 142 of a corresponding one of the at least one first lead 140. As such, the at least one first lead 140 may generally have a larger diameter than the at least one second lead 160, whoever, in other optional embodiments, the relationship may be reversed. In certain optional embodiments, each of the at least one second lead 160 may be slidably received into the first end 142 of a corresponding one of the at least one first lead 140 thus creating a telescoping assembly enabled for linear movement, for example, along at least one axis.

The at least one second lead 160 may further be in electrical contact with the at least one first lead 140 such that when the at least one first lead 140 is coupled to a power source 102, the power from said power source 102 is transmitted into the at least one second lead 160. The at least one first lead 140 and the at least one second lead 160 may be made from copper or any other appropriate electrically conductive material.

The power transmission assembly 100 may further include at least one brush block 180. Each of the at least one brush block 180 may be disposed at the first end 142 of a corresponding one of the at least one first lead 140. At least a portion of the at least one brush block 180 may extend beyond the first end 142 of the corresponding one of the at least one first lead 140. The at least one brush block 180 may be configured to maintain electrical contact between the at least one first lead 140 and a corresponding one of the at least one second lead 160. Each of the at least one brush block 180 may include an electrical motor brush 182 (shown in FIG. 6) positioned within a channel 181 of the at least one brush block 180 and configured to contact the corresponding one of the at least one second lead 160. The electrical motor brush 182 may also be referred to herein as a graphite motor brush 182. The channel 181 may be positioned past the first end 142 of the at least one first lead 140. Each of the at least one brush block 180 may further include a spring 184 configured to bias the electrical motor brush 182 towards the corresponding one of the at least one second lead 160. Each of the at least one brush block 180 may further include a set screw 186 that allows for adjustment of the spring force.

A width of the brush block 180 may be about 1.25× to about 1.5× a diameter of the at least one first lead 140. In other optional embodiments, the width of the brush block 180 may be about 1.25× to about 1.5× a diameter of the at least one first lead 140.

A width of the electrical motor brush 182 may be greater than or equal to the diameter of the at least one second lead 160. In other optional embodiments, the width of the electrical motor brush 182 may be less than or equal to the diameter of the at least one second lead 160.

The power transmission assembly 100 may further include at least one O-ring 170 positioned on each of the at least one second lead 160. The at least one O-ring 170 may allow for smooth linear motion while still maintaining concentricity between the first and second leads 140, 160. The at least one O-ring 170 may also be referred to herein as at least one high-temperature O-ring. The at least one O-ring 170 may be configured to create a seal between the at least one first lead 140 and the at least one second lead 160. In certain optional embodiments, the at least one second lead 160 may include at least one groove (not shown) configured to receive the at least one O-ring 170. The at least one groove may prevent the O-ring 170 from moving as the second lead 160 moves relative to the first lead 140. The at least one groove may be positioned within about 2 inches from the end of the at least one second lead 160. In certain optional embodiments, each of the at least one second lead 160 may include two grooves, one positioned about 0.25 inch from the end of the at least one second lead 160 and another positioned about 0.5 inch from the end of the at least one second lead 160. In other optional embodiments, the at least one groove may be positioned elsewhere along the at least one second lead 160, however, the at least one groove may generally be positioned on the at least one second lead 160 where it overlaps with the at least one first lead 140. The closer the at least one groove is positioned to the end of the at least one second lead 160, the less cooling fluid that will fill the gap between the at least one first lead 140 and the at least one second lead 160.

Each of the at least one first lead 140 may include a first lead wall thickness and a first cross-sectional area determined at least in part by the first lead wall thickness. Similarly, each of the at least one second lead 160 may include a second lead wall thickness and a second cross-sectional area determined at least in part by the second lead wall thickness. Each of the first cross-sectional area and the second cross-sectional area is the area available for electrical current to travel through. The maximum electrical current that can travel through the first and second leads 140, 160 may be limited by whichever one has a smaller cross-sectional area.

In certain optional embodiments, wherein each of the at least one first lead 140 and the at least one second lead 160 is tubular, the respective cross-sectional areas may be calculated by subtracting an area determined using the inner diameter from an area determined using the outer diameter. Each of the first cross-sectional area and the second cross-sectional area generally need to be greater than or equal to the minimum AWG size to supply the correct amount of power to the inductive coil 116. More specifically, the AWG size needs to be able to handle the required amount of voltage and current needed by the inductive coil 116. For example, if the OD is 0.375″ and the ID is 0.311″, the resulting functional cross-sectional area is roughly 0.0345 sq. inches, or comparable to a 20 AWG wire.

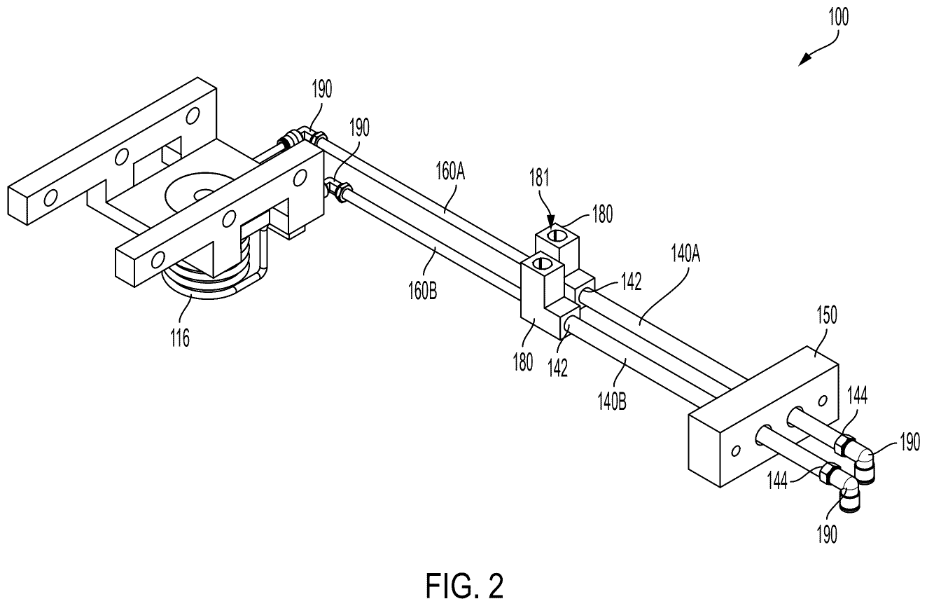

As illustrated in FIGS. 2-5, the at least one first lead 140 may include a first supply lead 140A and a first return lead 140B positioned parallel to the first supply lead 140A. Each of the first supply lead 140A and the first return lead 140B may be rigidly coupled to the print chamber 112. Each of the first supply lead 140A and the first return lead 140B may extend through a wall 113 of the print chamber 112. In other optional embodiments, the first supply lead 140A and/or the first return lead 140B may alternatively be routed through a ceiling of the print chamber 112, a platform of the print chamber 112, or through any other part of the print chamber 112. Each of the first supply lead 140A and the first return lead 140B may be coupled to the power source 102 outside of the print chamber 112. For example, the first supply lead 140A may be electrically coupled to a positive terminal of the power source 102 and the first return lead 140B may be electrically coupled to a negative terminal of the power source 102.

Similarly, the at least one second lead 160 may include a second supply lead 160A and a second return lead 160B. The second supply lead 160A may be slidably received by the first supply lead 140A and may further be in electrical contact with the first supply lead 140A. The second return lead 160B may be slidably received by the first return lead 140B and may further be in electrical contact with the first return lead 140B.

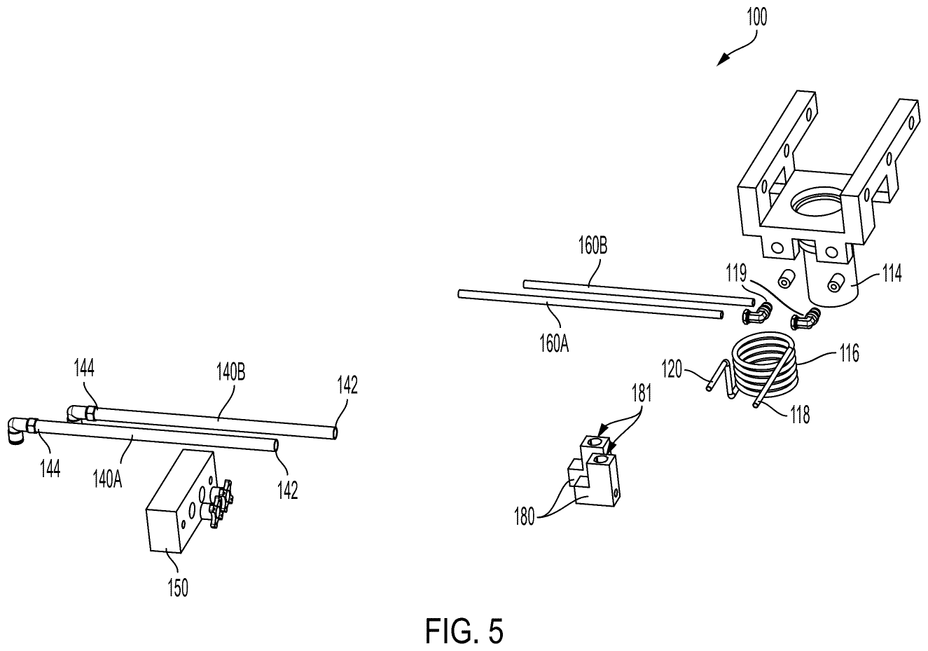

The first and second supply leads 140A, 160A and the first and second return leads 140B, 160B in combination with the inductive coil 116 may define a power transmission system. The inductive coil 116 may include a first coil end 118 and a second coil end 120 as shown in FIG. 5. The first coil end 118 may be coupled to second supply lead 160A and the second coil end 120 may be coupled to the second return lead 160B, for example, using electrically conductive fittings 190, or alternatively, by bending one or more of the coil or leads. As such, an electrical circuit may be defined by the first supply lead 140A, the second supply lead 160A, the conductive coil 115, the first return lead 140B, and the second return lead 160B in combination with the power source 102 for enabling the inductive coil 116 to heat up the print head 114.

In certain optional embodiments, a passageway may be defined through each of the first supply lead 140A, the second supply lead 160A, the conductive coil 115, the first return lead 140B, and the second return lead 160B for receiving a cooling fluid (e.g., water or the like) for selectively cooling the inductive coil 116. In other optional embodiments, each of the first supply lead 140A, the second supply lead 160A, the first return lead 140B, and the second return lead 160B may include an electrically insulative interior coating configured to separate the cooling fluid from the electrically charged exterior material. The electricity travels through the cooling fluid and the conductive elements of the passageway (e.g., copper) proportional to their resistance, and as such the cooling fluid has little effect on the electrical flow through the conductive elements. The vast majority of current is transmitted through the rigid system (e.g., the conductive elements of the passageway), and as both the cooling and electrical systems are sealed and insulated at their mounting points, it forms a closed loop system.

In certain optional embodiments, the power transmission assembly 100 may include electrically conductive fittings 190 for redirecting the passageway formed by the at least one first lead 140 and the at least one second lead 160.

Each of the paired first and second leads 140, 160 are generally limited to accommodating one directional (or single axis) movement of the print head 114. In certain optional embodiments, additional first and second telescoping concentric leads may be positioned in series with the those of the power transmission assembly 100, as disclosed herein, for example, by using elbow fittings, to functionally accommodate multi-directional (or multi-axis) movement of the print head 114.

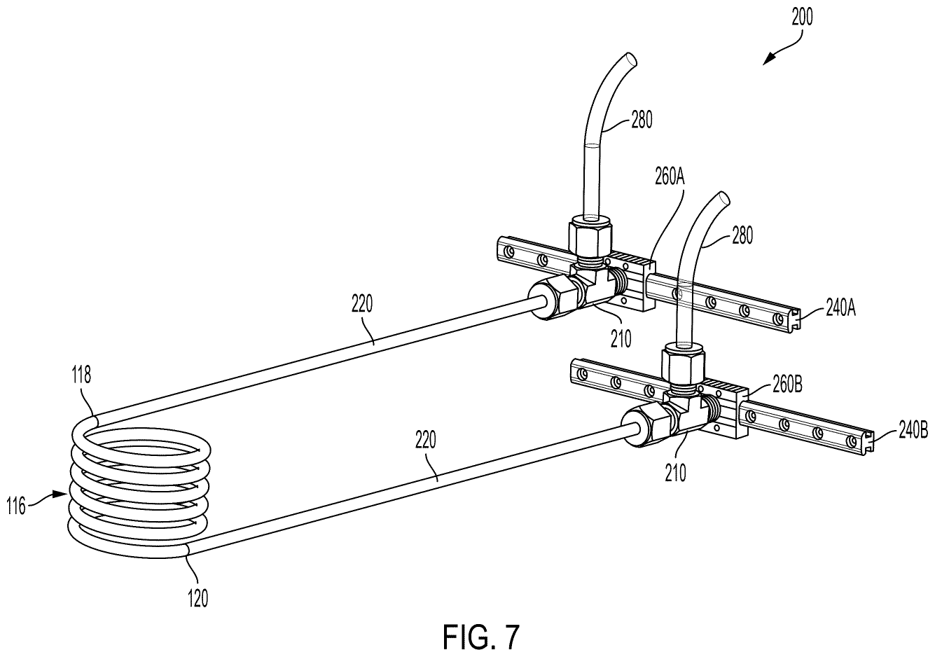

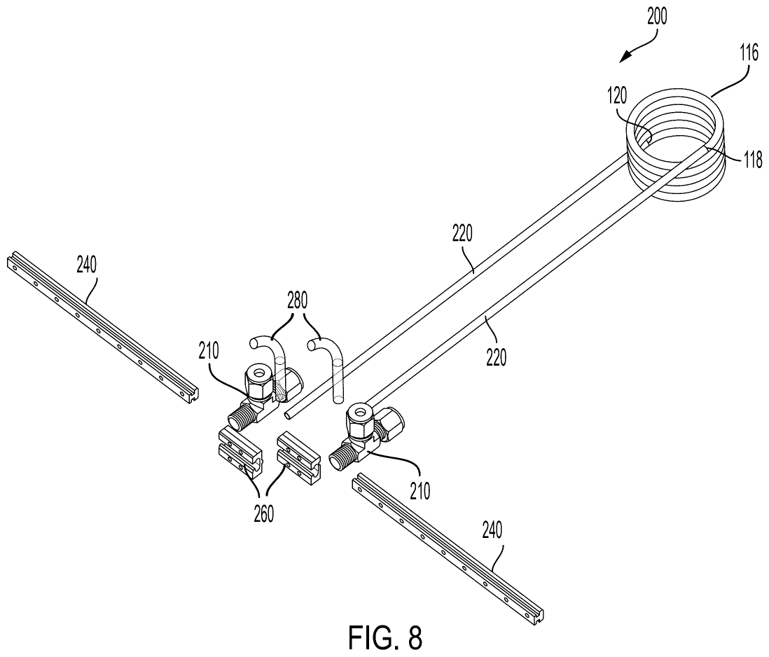

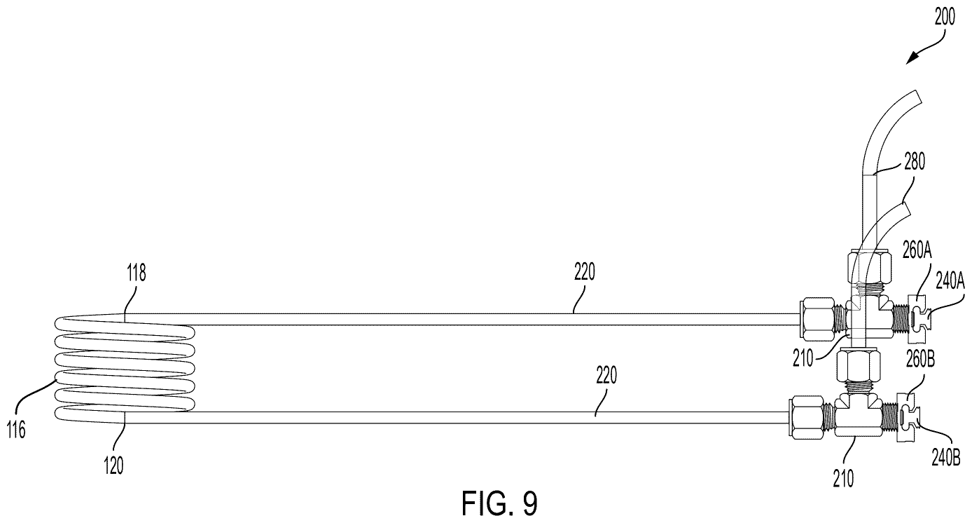

Referring to FIGS. 7-9, another embodiment of a power transmission assembly 200 for the 3D printer 110 is illustrated. The power transmission assembly 200 may be configured to provide electrical energy to the inductive coil 116. In certain optional embodiments, the power transmission assembly 200 may be configured to also provide cooling fluid (e.g., water or the like) for selectively cooling the inductive coil 116.

The power transmission assembly 200 may include at least one first conductive lead 240 and at least one second conductive lead 260. The at least one first conductive lead 240 may also be referred to herein as at least one conductive track 240. The at least one second conductive lead 260 may also be referred to herein as at least one sliding block 260, at least one carriage 260, or at least one captured carriage 260. The at least one sliding block 260 may be captured by and slide along the at least one conductive track 240, for example, to enable one directional (or single axis) movement of the print head (not shown). In certain optional embodiments, the at least one conductive track 240 may be coupled to an additional sliding block which may be slidably coupled to an additional conductive track extending in a different direction from the at least one conductive track 240 for enabling multi-directional (or multi-axis) movement of the print head.

The at least one conductive track 240 may be configured to be coupled to a wall of the print chamber and be electrically separate from the print chamber, for example, using a non-conductive spacer. In certain optional embodiments, the at least one conductive track 240 may be made from an electrically conductive material and may be mounted in a non-conductive insulation. The at least one conductive track 240 may be T-shaped and the at least one sliding block 260 may be U-shaped to allow smooth motion in the track while also staying captured.

The power transmission assembly 200 may further include a fitting 210 coupled to each of the at least one sliding block 260 and an extension lead 220 extending from the fitting 210. The extension lead 220 may be coupled to one of the first coil end 118 or the second coil end 120 of the inductive coil 116, for example, by means of a fitting or made directly from the material of the inductive coil 116. In certain optional embodiments, the extension lead 220 may extend from the at least one sliding block 260 in a direction perpendicular to the at least one conductive track 240. In other optional embodiments, the extension lead 220 may include a bend and extend from the at least one sliding block 260 in a direction parallel to the at least one conductive track 240. The extension lead 220 may have a functional cross-sectional area comparable to an appropriate AWG wire size for the power requirements, similar to the above description.

In certain optional embodiments, a size of a raised portion of the at least one sliding block 260 connecting to the extension lead 220 should be roughly 1.25× to 1.5× the diameter of the extension lead 220. In other optional embodiments, a flange of at least one of the at least one sliding block 260 or the at least one conductive track 240 may be roughly 0.25× of the size of the raised portion on each side to ensure reliable electrical transfer and a secure hold.

The at least one conductive track 240 may include a supply track 240A and a return track 240B positioned parallel to the supply track 240A. Each of the supply track 240A and the return track 240B may be rigidly coupled to the print chamber. Each of the supply track 240A and the return track 240B may be coupled to a power source 102 positioned outside of the print chamber. For example, the supply track 240A may be electrically coupled to a positive terminal of the power source 102 and the return track 240B may be electrically coupled to a negative terminal of the power source 102.

Similarly, the at least one sliding block 260 may include a supply sliding block 260A and a return sliding block 260B. The supply sliding block 260A may be slidably received by the supply track 240A and may further be in electrical contact with the supply track 240A. The return sliding block 260B may be slidably received by the return track 240B and may further be in electrical contact with the return track 240B.

The supply tracks 240A, 260A and the return sliding blocks 240B, 260B in combination with the inductive coil 116 may define a power transmission system. The first coil end 118 may be coupled to supply sliding block 260A and the second coil end 120 may be coupled to the return sliding block 260B. As such, an electrical circuit may be defined by the supply track 240A, the supply sliding block 260A, the inductive coil 116, the return track 240B, and the return sliding block 260B in combination with the power source 102 for enabling the inductive coil 116 to heat up the print head 114.

In certain optional embodiments, a passageway may be defined through each of fittings 210, the inductive coil 116, and the extension leads 220 for receiving a cooling fluid (e.g., water or the like) for selectively cooling the inductive coil 116. The fitting 210 may comprise a tee joint allowing a water line 280 hookup as seen in FIGS. 7-9. As mentioned above, the interaction between the cooling fluid and the conductive elements of the passageway has little effect on the electrical flow through the conductive elements due to the system being a closed loop.

In certain optional embodiments, each of the at least one first conductive lead 240 may be a track or a carriage and each of the at least one second conductive lead 260 may a different one of the track or the carriage. Which is which has no bearing on the actual function of the power transmission assembly 200.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A power transmission assembly for a 3D printer having a printing chamber, a print head, and an inductive coil wound around at least a portion of the print head, the power transmission assembly comprising:
a first lead, at least a portion of the first lead configured to be positioned within the printing chamber of the 3D printer, the first lead configured to be coupled to a power source external to the 3D printer; and
a second lead configured to be positioned within the printing chamber of the 3D printer, the second lead slidably coupled to and in electrical contact with the first lead,
wherein the first and second leads are configured to transmit power from the power source to the inductive coil.

2. The power transmission assembly of claim 1, wherein the first lead is configured to extend through a wall of the printing chamber of the 3D printer and be rigidly coupled to the wall using a non-conductive housing block.

3. The power transmission assembly of claim 2, wherein:
the non-conductive housing block is configured to create a seal between a closed environment within the printing chamber of the 3D printer and an open environment outside of the printing chamber.

4. The power transmission assembly of claim 2, wherein:
the non-conductive housing block is configured to insulate the first lead from contact with the printing chamber of the 3D printer.

5. The power transmission assembly of claim 1, further comprising:
a brush block disposed at a first end of the first lead and configured to maintain electrical contact with the second lead.

6. The power transmission assembly of claim 5, wherein:
the brush block further includes an electrical motor brush configured to contact the second lead, a width of the electrical motor brush being greater than or equal to a dimeter of the second lead.

7. The power transmission assembly of claim 6, wherein:
the brush block further includes a spring configured to bias the electrical motor brush towards the second lead.

8. The power transmission assembly of claim 5, wherein:
a width of the brush block is about 1.25 times to about 1.5 times a diameter of the first lead.

9. The power transmission assembly of claim 1, wherein:
the first lead is configured to be coupled to a water source external to the 3D printer and transmit water from the water source through the second lead to the inductive coil for cooling the inductive coil.

10. The power transmission assembly of claim 9, further comprising:
at least one O-ring disposed on the second lead between the first lead and the second lead, the at least one O-ring configured to create a seal for preventing the water from leaking.

11. The power transmission assembly of claim 10, wherein:
the at least one O-ring is positioned within 2 inches of an end of the second lead.

12. The power transmission assembly of claim 1, wherein:
the second lead is configured to move axially relative to the first lead.

13. The power transmission assembly of claim 1, wherein:
the first lead includes a first lead wall thickness and a first cross-sectional area determined at least in part by the first lead wall thickness; and
the second lead includes a second lead wall thickness and a second cross-sectional area determined at least in part by the second lead wall thickness.

14. The power transmission assembly of claim 11, wherein:
the first cross-sectional area and the second cross-sectional area are greater than or equal to a minimum AWG size to supply power to the inductive coil.

15. The power transmission assembly of claim 1, wherein one of the first lead and the second lead comprises a track and the other of the first lead and the second lead comprises a captured carriage slidably coupled to the track.

16. A power transmission system for a 3D printer, the power transmission system comprising:
a first supply lead rigidly coupled to a chamber of the 3D printer, the first supply lead configured to be coupled to a power source;
a second supply lead slidably received by the first supply lead and in electrical contact with the first supply lead;
a first return lead rigidly coupled to the chamber of the 3D printer, the first return lead configured to be coupled to the power source;
a second return lead slidably received by the first return lead and in electrical contact with the first return lead; and
a conductive coil wound around a print head of the 3D printer, the conductive coil including a first coil end and a second coil end, the second supply lead coupled to the first coil end, and the second return lead coupled to the second coil end.

17. The power transmission system of claim 16, wherein:
a passageway is defined through each of the first supply lead, the second supply lead, the first return lead, the second return lead, and the conductive coil.

18. The power transmission system of claim 17, wherein:
the passageway is configured to receive a fluid for cooling the conductive coil.

19. The power transmission system of claim 16, wherein:
each of the first supply lead and the first return lead include a brush block coupled thereto and positioned proximate the second supply lead or the second return lead, respectively, the brush block configured to maintain electrical contact between the first supply lead and the second supply lead or the first return lead and the second return lead, respectively.

20. The power transmission system of claim 16, wherein:
an electrical circuit is defined by the first supply lead, the second supply lead, the first return lead, the second return lead, and the conductive coil.
